(19) United States
(12) Patent Application Publication
(10) Pub. No.: US 2004/0242200 A1
(43) Pub. Date: Dec. 2, 2004

(54) Communication system

(75) Inventors: Jun Maeoka, Kawasaki (JP); Motoaki Satoyama, Sagamihara (JP); Yoshiaki Morimoto, Kawasaki (JP); Akihiko Yamamoto, Tokai (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/719,597

(22) Filed: Nov. 20, 2003

(30) Foreign Application Priority Data
May 28, 2003 (JP) 2003-150553

(51) Int. Cl. H04M 1/66

(52) U.S. Cl. 455/411; 713/168

(57) ABSTRACT

An approval request communication terminal carried by a child, etc. has a program processor for performing the execution processing of various kinds of function programs. When a predetermined condition is satisfied, the approval request communication terminal makes an approval request message of the execution processing of a function program, and transmits this approval request message to an approval processing communication terminal carried by a parent, etc. When the approval processing terminal receives the approval request message, the approval processing terminal displays contents based on this message, and receives the input of a reply to this message, and makes an approval message based on the reply, and transmits this approval message to the approval request terminal. When the approval request terminal receives the approval message, the approval request terminal controls the execution processing of the function program using the program processor in accordance with the contents of this approval message.

### BACKGROUND OF THE INVENTION

The present invention relates to a communication terminal having a function for executing a function program, this operation program and a communication system, and particularly relates to the communication terminal, the operation program and the communication system for limiting the execution of the function program.

A portable communication terminal such as a portable telephone, etc. and a communication terminal such as a computer, etc. can execute various kinds of function programs such as a voice call, an electronic mail, a Web browser, etc. A user starts a predetermined desirable function program by using an input device such as a starting menu, a button, etc. of the terminal.

In such a communication terminal, there is a terminal having a limiting function for limiting and invalidating the execution of the function program through a network from another communication terminal.

For example, there is a portable telephone carried from a parent to a child so as to perform communication, the portable telephone has structure having the limiting function in which no signal can be transmitted and only a signal from a predetermined communication partner is received. Further, Japanese patent laid-open publication No. 2001-95060 discloses a portable telephone in which the use of a function is automatically limited within a certain area and the limit is released when the portable telephone is dislocated from this area.

As mentioned above, in the prior art, the structure for limiting the use of various kinds of function programs, etc. exists, but this using limit is fixed. Therefore, problems exist in that no measures according to situations can be taken and this using limit is rather complicated and inconvenient, etc. for the user in certain cases.

### SUMMARY OF THE INVENTION

The present invention notices such conventional problems and an object of the present invention is to provide a communication system able to change the using limit of the function of the communication terminal in accordance with the situations and raise convenience for the user, a communication terminal constituting this communication system, and an operation program of this communication terminal.

A first communication terminal for an approval request for solving the above problem is a communication terminal comprising program processing means for performing the execution processing of various kinds of programs, and communication means for performing communication between the communication terminal and the exterior;

the communication terminal further comprising:

approval request processing means for making an approval request message of the execution processing of a predetermined program among said various kinds of programs and transmitting the approval request message to another predetermined communication terminal by said communication means when a predetermined condition is satisfied with respect to the predetermined program; and

program executing managing means for controlling said execution processing using said program processing means in accordance with the contents of a reply message to said approval request message when said communication means receives the reply message from said another communication terminal.

A second communication terminal for the approval request for solving the above problem is characterized in that the predetermined condition in the first communication terminal is one of the reception of a starting request of said predetermined program, the passage of a predetermined executing time interval with respect to the predetermined program, and the reception of a making request of said approval request message from a user with respect to the predetermined program.

A third communication terminal for the approval request for solving the above problem is characterized in that the program executing managing means in one of the first and second communication terminals makes said program processing means perform the execution processing of the predetermined program if said reply message shows contents recognizing the execution of the predetermined program with respect to the execution processing of said predetermined program requesting the approval in said approval request message, and also makes said program processing means perform no execution processing of the predetermined program if the reply message shows contents recognizing no execution of the predetermined program.

A fourth communication terminal for the approval request for solving the above problem is characterized in that the program executing managing means in the third communication terminal makes the program processing means perform the execution processing of the predetermined program requiring the approval in said approval request message when a starting request of this predetermined program is received during only an effective time limit if the reply message shows contents recognizing the execution of the predetermined program in the effective time limit with respect to this execution processing of the predetermined program.

A fifth communication terminal for the approval request for solving the above problem is characterized in that position information obtaining means for obtaining information of the present place of the self communication terminal is arranged in one of the first to fourth communication terminals, and

the approval request processing means includes the position information obtained by said position information obtaining means in said approval request message.

A sixth communication terminal for the approval request for solving the above problem is characterized in that approval request rule memory means for storing a rule with respect to the approval request every each of said various kinds of programs is arranged in one of the first to fifth communication terminals, and

said approval request processing means performs processing in accordance with said rule stored in said approval request rule memory means.

A seventh communication terminal for the approval request for solving the above problem is characterized in that the rule in the sixth communication terminal includes which is the predetermined program among the various kinds of programs, and also includes the predetermined condition.

An eighth communication terminal for the approval request for solving the above problem is characterized in that the rule in one of the sixth and seventh communication terminals includes discriminating information for communication of the above another predetermined communication terminal.

A ninth communication terminal for the approval request for solving the above problem is characterized in that said rule in one of the sixth to eighth communication terminals includes information of communication impossible time processing for determining what processing is performed with respect to said predetermined program at the communication impossible time with said another predetermined communication terminal.

A tenth communication terminal for the approval request for solving the above problem is characterized in that, with respect to one of programs except for said predetermined program among said various kinds of programs, said rule in one of the sixth to ninth communication terminals includes the transmission of an execution log of this program instead of the transmission of said approval request message.

An eleventh communication terminal for the approval request for solving the above problem is characterized in that rule changing means for changing the rule stored in the approval request rule memory means is arranged in one of the sixth to tenth communication terminals, and changes the rule only when a predetermined procedure is carried out.

A twelfth communication terminal for the approval request for solving the above problem is characterized in that, in one of the first to eleventh communication terminals,

the twelfth communication terminal has:

authentication information memory means for storing key information for performing signature processing of the self terminal; and

signature processing means for performing the signature processing for proving that the approval request message is a message of the self terminal by using the key information.

A thirteenth communication terminal for the approval request for solving the above problem is characterized in that, in the above twelfth communication terminal,

certificate information for authenticating the above another communication terminal of an approval request destination is stored in the authentication information memory means, and

signature verification processing means for performing signature verification processing of the reply message by using the certificate information is arranged.

A fourteenth communication terminal for the approval request for solving the above problem is characterized in that cipher processing means for ciphering the approval request message is arranged in one of the first to thirteenth communication terminals.

A fifteenth communication terminal for the approval request for solving the above problem is characterized in that, in one of the first to fourteenth communication terminals,

if the reply message is ciphered, deciphering means for deciphering the ciphered reply message is arranged.

A sixteenth communication terminal for the approval request for solving the above problem is characterized in that said predetermined program is a game program and the communication terminal is a game machine in one of the first to fifteenth communication terminals.

A first communication terminal for approval processing for solving the above problem is a communication terminal comprising input means for receiving an input from a user, output means for outputting information, and communication means for performing communication between the communication means and the exterior,

the communication terminal further comprising approval processing means which makes said output means output contents based on an approval request message showing the desire of approval with respect to the execution of a predetermined program when said communication means receives the approval request message from another communication terminal, and makes a reply message based on a reply to the approval request message when said input means receives the input of the reply, and transmits the reply message to the another communication terminal by the communication means.

A second communication terminal for the approval processing for solving the above problem is characterized in that approval processing rule memory means for storing a rule relative to the approval processing every the above predetermined program is arranged in the above first communication terminal for the approval processing, and

the approval processing means performs processing in accordance with the rule stored in the approval processing rule memory means.

A third communication terminal for the approval processing for solving the above problem is characterized in that the rule in the above second communication terminal for the approval processing includes an approval processing method for determining at which time the approval processing using the approval processing means is performed every the above predetermined program.

A fourth communication terminal for the approval processing for solving the above problem is characterized in that the rule includes discriminating information for communication of the above another communication terminal as a transmission destination of the reply message every the above predetermined program in one of the above second and third communication terminals for the approval processing.

A fifth communication terminal for the approval processing for solving the above problem is characterized in that, in one of the above first to fourth communication terminals for the approval processing, the fifth communication terminal further has:

log memory means for storing a log of the program executed by said another communication terminal; and

log processing means for storing the log to said log memory means when said communication means receives said log from said another communication terminal, and calling the log out of the log memory means and outputting the log to said output means when a perusing request of the log is received by said input means.

A sixth communication terminal for the approval processing for solving the above problem is characterized in that, in one of the first to fifth communication terminals for the approval processing,

the sixth communication terminal has:

authentication information memory means for storing key information for performing signature processing of the self terminal; and

signature processing means for performing signature processing for proving that the reply message is a message of the self terminal by using the key information.

A seventh communication terminal for the approval processing for solving the above problem is characterized in that, in the sixth communication terminal for the approval processing,

certificate information for authenticating the above another communication terminal of an approval request source is stored in the authentication information memory means, and

signature verification processing means for performing signature verification processing of the approval request message by using the certificate information is arranged.

An eighth communication terminal for the approval processing for solving the above problem is characterized in that cipher processing means for ciphering the reply message is arranged in the first to seventh communication terminals for the approval processing.

A ninth communication terminal for the approval processing for solving the above problem is characterized in that, in one of the first to eighth communication terminals for the approval processing, if the approval request message is ciphered, deciphering means for deciphering the ciphered approval request message is arranged.

A communication system for solving the above problem is characterized in that the communication system has: one of the first to sixteenth communication terminals for the approval request; and

one of the first to ninth communication terminals for the approval processing which receives said approval request message from said communication terminal and returns said reply message to the approval request message.

A portable telephone set suitable for management of the execution processing of various kinds of programs is a portable telephone set comprising program processing means for performing the execution processing of the various kinds of programs, and communication means for performing communication between the communication means and the exterior,

wherein, with respect to a predetermined program among said various kinds of programs, the portable telephone set further comprises log processing means for transmitting a log of the predetermined program to another predetermined communication terminal by said communication means when the predetermined program is executed and processed by said program processing means.

Another portable telephone set suitable for the management of the execution processing of various kinds of programs is a portable telephone set comprising input means for receiving an input from a user, output means for outputting information, and communication means for performing communication between the communication means and the exterior;

the portable telephone set further comprising:

log memory means for storing the log of a program executed by another communication terminal; and

log processing means for storing the log to said log memory means when said communication means receives said log from said another communication terminal, and calling the log out of the log memory means and outputting the log to said output means when a perusing request of the log is received by said input means.

An operation program of the first communication terminal for the approval request for solving the above problem is an operation program of a communication terminal comprising program processing means for performing the execution processing of various kinds of function programs, and communication means for performing communication between the communication means and the exterior,

the operation program executing:

an approval request processing step for making an approval request message of the execution processing of a predetermined function program among said various kinds of programs when a predetermined condition is satisfied with respect to the predetermined function program, and transmitting the approval request message to another predetermined communication terminal by said communication means; and

a program executing managing step for controlling said execution processing using said program processing means in accordance with the contents of a reply message to said approval request message when said communication means receives the reply message from said another communication terminal.

An operation program of the second communication terminal for the approval request for solving the above problem is characterized in that the predetermined condition in the operation program of the first communication terminal is one of the reception of a starting request of the predetermined function program, the passage of a predetermined executing time interval with respect to the function program, and the reception of a making request of the approval request message from a user with respect to the function program.

An operation program of the third communication terminal for the approval request for solving the above problem is characterized in that the program processing means in the program executing managing step in the operation program of one of the first and second communication terminals performs the execution processing of the predetermined function program if said reply message shows contents recognizing the execution of the predetermined function program with respect to the execution processing of said predetermined function program requesting the approval in said approval request message, and also performs no execution processing of the predetermined function program if the reply message shows contents recognizing no execution of the predetermined function program.

An operation program of the fourth communication terminal for the approval request for solving the above problem is characterized in that the program processing means in the program executing managing step in the operation program of the third communication terminal performs the execution processing of the predetermined function program requiring the approval in said approval request message when a starting request of the predetermined function program is received during only an effective time limit if the reply message shows contents recognizing the execution of the predetermined function program in the effective time limit with respect to this execution processing of the predetermined function program.

An operation program of the fifth communication terminal for the approval request for solving the above problem is characterized in that, in the operation program of one of the first to fourth communication terminals, a position information obtaining step for obtaining information of the present place of the self communication terminal is executed, and

the position information obtained in said position information obtaining step is included in said approval request message in the approval request processing step.

An operation program of the sixth communication terminal for the approval request for solving the above problem is characterized in that, in the operation program of one of the first to fifth communication terminals,

the rule is called out of the approval request rule memory means storing the rule relative to the approval request every each of the various kinds of function programs, and processing is performed in accordance with the rule in the approval request processing step.

An operation program of the seventh communication terminal for the approval request for solving the above problem is characterized in that the rule in the operation program of the sixth communication terminal includes which is the predetermined function program among the various kinds of programs, and also includes the predetermined condition.

An operation program of the eighth communication terminal for the approval request for solving the above problem is characterized in that the rule in the operation program of one of the sixth and seventh communication terminals includes discriminating information for communication of the above another predetermined communication terminal.

An operation program of the ninth communication terminal for the approval request for solving the above problem is characterized in that said rule in the operation program of one of the sixth to eighth communication terminals includes information of communication impossible time processing for-determining what processing is performed with respect to said predetermined function program at the communication impossible time with said another predetermined communication terminal.

An operation program of the tenth communication terminal for the approval request for solving the above problem is characterized in that, with respect to one of function programs except for said predetermined function program among said various kinds of function programs, said rule in the operation program of one of the sixth to ninth communication terminals includes the transmission of an execution log of this program instead of the transmission of said approval request message.

An operation program of the eleventh communication terminal for the approval request for solving the above problem is characterized in that, in the operation program of one of the sixth to tenth communication terminals, a rule changing step for changing the rule stored in the approval request rule memory means is executed only when a predetermined procedure is carried out.

An operation program of the twelfth communication terminal for the approval request for solving the above problem is characterized in that a signature processing step for performing signature processing for proving that the approval request message is a message of the self terminal, is executed by using key information for performing the signature processing of the self terminal stored in the authentication information memory means in the operation program of one of the first to eleventh communication terminals.

An operation program of the thirteenth communication terminal for the approval request for solving the above problem is characterized in that, in the operation program of the twelfth communication terminal,

certificate information for authenticating the above another communication terminal of an approval request destination is called out of the authentication information memory means, and a signature verification processing step for performing signature verification processing of the reply message is executed by using the certificate information.

An operation program of the fourteenth communication terminal for the approval request for solving the above problem is characterized in that a cipher processing step for ciphering the approval request message is executed in the operation program of one of the first to thirteenth communication terminals.

An operation program of the fifteenth communication terminal for the approval request for solving the above problem is characterized in that, if the reply message is ciphered in the operation program of one of the first to fourteenth communication terminals, a deciphering step for deciphering the ciphered reply message is executed.

An operation program of the first communication terminal for the approval processing for solving the above problem is an operation program of a communication terminal comprising input means for receiving an input from a user, output means for outputting information, and communication means for performing communication between the communication means and the exterior,

the operation program executing an approval processing step in which said output means outputs contents based on an approval request message showing the desire of approval with respect to the execution of a predetermined program when said communication means receives the approval request message from another communication terminal; a reply message based on a reply to the approval request message is made when said input means receives the input of the reply; and the reply message is transmitted to the another communication terminal by the communication means.

An operation program of the second communication terminal for the approval processing for solving the above problem is characterized in that, in the operation program of the first communication terminal for the approval processing,

a rule relative to the approval processing is called out of approval processing rule memory means storing this rule every the above predetermined function program, and processing is performed in accordance with the rule in the approval processing step.

An operation program of the third communication terminal for the approval processing for solving the above problem is characterized in that the rule in the operation program of the second communication terminal for the approval processing includes an approval processing method for determining at which time the approval processing in the approval processing step is performed every the predetermined program.

An operation program of the fourth communication terminal for the approval processing for solving the above problem is characterized in that the rule in the operation program of one of the second and third communication terminals for the approval processing includes discriminating information for communication of the above another communication terminal as a transmission destination of the reply message every the above predetermined program.

An operation program of the fifth communication terminal for the approval processing for solving the above problem is characterized in that, in the operation program of one of the first to fourth communication terminals for the approval processing,

the operation program of the fifth communication terminal executes a log processing step for storing the log to said log memory means when said communication means receives the log of the function program executed by said another communication terminal, and calling the log out of the log memory means and outputting the log to said output means when a perusing request of the log is received by said input means.

An operation program of the sixth communication terminal for the approval processing for solving the above problem is characterized in that, in the operation program of one of the first to fifth communication terminals for the approval processing,

a signature processing step for performing signature processing for proving that the reply message is a message of the self terminal is executed by using key information for performing the signature processing of the self terminal stored in the authentication information memory means.

An operation program of the seventh communication terminal for the approval processing for solving the above problem is characterized in that, in the operation program of the sixth communication terminal for the approval processing,

certificate information for authenticating the above another communication terminal of an approval request source is called out of the authentication information memory means, and a signature verification processing step for performing signature verification processing of the approval request message is executed by using the certificate information.

An operation program of the eighth communication terminal for the approval processing for solving the above problem is characterized in that a cipher processing step for ciphering the reply message is executed in the operation program of one of the first to seventh communication 1terminals for the approval processing.

An operation program of the ninth communication terminal for the approval processing for solving the above problem is characterized in that, in the operation program of one of the first to eighth communication terminals for the approval processing,

if the approval request message is ciphered, a deciphering step for deciphering the ciphered approval request message is executed.

An operation program of the communication terminal for solving the above problem is characterized in that this operation program has the operation program of one of the first to sixteenth communication terminals for the approval request, and the operation program of one of the first to ninth communication terminals for the approval processing.

A managing method of the program execution of the communication terminal for solving the above problem is a managing method of the program execution of a communication terminal having program processing means for performing the execution processing of various kinds of programs,

wherein said communication terminal makes an approval request message of the execution processing of a predetermined program among said various kinds of programs and transmits the approval request message to another predetermined communication terminal when a predetermined condition is satisfied with respect to the predetermined program;

said another communication terminal outputs contents based on the approval request message with respect to said predetermined program when said approval request message is received from said communication terminal, and makes a reply message based on a reply to the approval request message when the input of the reply is received, and transmits the reply message to the communication terminal; and

said communication terminal controls the execution processing of said predetermined program using said program processing means in accordance with the contents of the reply message to said approval request message when the reply message is received from said another communication terminal.

### BRIEF DESCRIPTION OF THE DRAWINGS

FIG. 1 is an explanatory view showing the constructions of an approval request terminal and an approval processing terminal of one embodiment mode in the present invention.

FIG. 2 is an explanatory view showing the data structure of an approval request rule DB of one embodiment mode in the present invention.

FIG. 3 is an explanatory view showing the data structure of an approval processing rule DB of one embodiment mode in the present invention.

FIG. 4 is an explanatory view showing the data structure of a log DB of one embodiment mode in the present invention.

FIG. 5 is a flow chart showing the procedures of approval request processing and approval processing of one embodiment mode in the present invention.

FIG. 6 is a flow chart showing the detailed processing of a step 508 in FIG. 5.

FIG. 7 is an explanatory view showing the data structure of an approval request message of one embodiment mode in the present invention.

FIG. 8A and 8B are an explanatory views showing an approval inquiring screen of one embodiment mode in the present invention, where FIG. 8A shows the approval inquiring screen of a call start and FIG. 8B shows the approval inquiring screen after the using time of the Internet 30 minutes has passed.

FIG. 9 is an explanatory view showing the data structure of an approval message of one embodiment mode in the present invention.

FIG. 10 is a flow chart showing the detailed processing of a step 626 in FIG. 6.

FIG. 11 is an explanatory view showing the schematic contents of transmission and reception of data between an approval request terminal and an approval processing terminal of one embodiment mode in the present invention.

### DETAILED DESCRIPTION OF PREFERRED EMBODIMENTS

Next, one embodiment mode of each of a communication terminal for an approval request and a communication terminal for approval processing in the present invention will be explained by using the drawings. In the explanation of the embodiment modes, common portions are designated by the same reference numerals and their overlapping explanations are omitted.

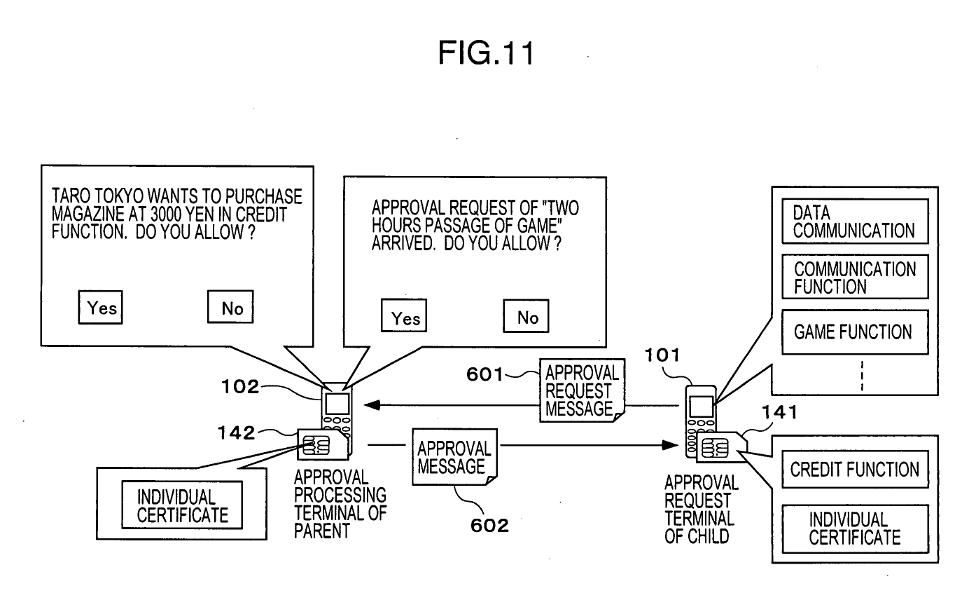

In this embodiment mode, as shown in FIG. 11, for example, a child has an approval request terminal 101 and its parent has an approval processing terminal 102. In such a case, when the child begins to use a function program such as data communication, a call, a game function and a credit function by the approval request terminal 101, or after a predetermined time has passed from the beginning of the use of the function program, the approval request terminal 101 transmits an approval request message 601 of this use to the approval processing terminal 102 carried by the parent. The parent sees the contents of the approval request displayed in a display portion in the approval processing terminal 102, and determines allowance/unallowance of the use of the function program, and inputs its result to the approval processing terminal 102. The approval processing terminal 102 returns an approval message (reply message) 602 to the approval request terminal 101 carried by the child. This approval request terminal 101 itself controls starting of the function program in accordance with the contents of this approval message 602, i.e., the use allowance/unallowance of the function program. In the above example, the approval request terminal 101 and the approval processing terminal 102 are constructed by a portable communication terminal such as a portable telephone, a PDA, etc., but may be also set to any terminal if this terminal is a terminal having a communication function such as a game machine, a computer, etc. having the communication function.

The constructions of the approval request terminal 101 and the approval processing terminal 102 of this embodiment mode and their operations will be explained below concretely.

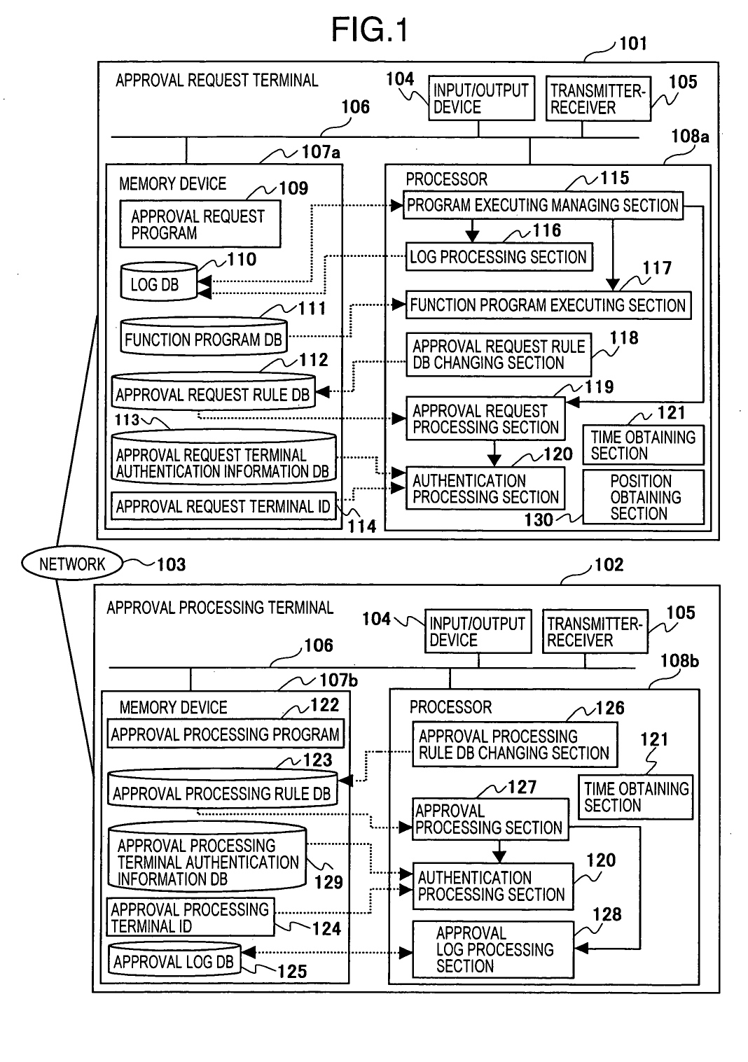

As shown in FIG. 1, the approval request terminal 101 and the approval processing terminal 102 of this embodiment mode are connected so as to be mutually communicated by a network 103. In the above example, this network 103 is a wireless network, but may be also set to any network without being limited to wired and wireless networks if this network is a network able to be mutually communicated. In FIG. 1, one approval request terminal 101 and one approval processing terminal 102 are connected to the network 103, but plural approval request terminals 101 and plural approval processing terminals 102 maybe also connected to the network 103.

Each of the approval request terminal 101 and the approval processing terminal 102 has an input/output device 104, a transmitter-receiver 105, processors 108a, 108b , memory devices 107a, 107b and an internal bus 106 or mutually connecting these devices. Each component is connected to unillustrated battery and power source so that electric power required to operate each component is supplied.

The input/output device 104 is a device for displaying information to a user and receiving the input of data from the user. For example, there are a ten-key and a microphone as the input device, and there are a liquid crystal display and a speaker as the output device. However, the input device and the output device are not limited to these devices if the input and output devices are devices for performing the inputting operation from the user and the outputting operation to the user. Further, the input device and the output device may be also separately arranged and constructed.

The transmitter-receiver 105 controls the communication with the external network 103 and receives data and transmits these data to the processor 108. The transmitter-receiver 105 also receives data from the processors 108a, 108b and transmits these data to the external network 103. In FIG. 1, the transmitter-receiver 105 performs both the transmitting and receiving operations, but may be also constructed so as to separately have the transmitter and the receiver.

For example, the memory devices 107a, 107b may be set to any devices if these devices are devices able to store information such as a hard disc device, a semiconductor memory, an IC card, etc.

As mentioned above, an approval request program 109 for making the approval request message, etc., a log DB 110 for storing starting and terminating times of the execution of each program, etc., a function program DB 111 for storing various kinds of function programs, an approval request rule DB 112 for storing a rule in transmitting the approval request message, an approval request terminal authentication information DB 113 for storing information for performing authentication processing by a laid-open key cipher system, and an approval request terminal ID 114 for specifying its own terminal are stored in the memory device 107a of the approval request terminal 101.

Further, as mentioned above, an approval processing program 122 for making the approval message with respect to the approval request message, etc., an approval processing rule DB 123 for storing a rule for performing the approval processing, an approval processing terminal authentication information DB 129 for storing information for performing the authentication processing in the laid-open key cipher system, an approval processing terminal ID 124 for specifying its own terminal, and an approval log DB 125 for storing a log of the approval request are stored in the memory device 107b of the approval processing terminal 102.

As shown in FIG. 11, when the terminals 101, 102 are portable telephones, the approval request terminal authentication information DB 113 stored in the memory device 107a of the approval request terminal 101 and the approval processing terminal authentication information DB 129 stored in the memory device 107b of the approval processing terminal 102 are stored in UIM (User Identify Module) cards 141, 142 as one kind of the memory device in many cases.

As mentioned above, the approval request program 109, the approval processing program 122 and the function program DB 111 among the data stored in the memory devices 107a , 107b are stored in the memory devices 107a, 107b by an unillustrated reader when each of the terminals 101, 102 is manufactured. Otherwise, data stored and transacted in the memory medium such as a CD-ROM, etc. may be also stored in the memory devices 107a, 107b by the unillustrated reader. Further, data transacted through the network 103 maybe also stored in the memory devices 107a, 107b by the unillustrated reader. The approval request program 109, the approval processing program 122 and the function program DB 111 are sequentially read from the memory devices 107a, 107b to a work memory and are executed by the processors 108a, 108b.

Thus, the approval request program 109 executed by the processor 108a of the approval request terminal 101 functionally has a program executing managing section 115, a log processing section 116, a function program executing section 117, an approval request rule DB changing section 118, an approval request processing section 119 and an authentication processing section 120. The processor 108a functionally has a time obtaining section 121 and a position obtaining section 130 in addition to the above functions. The program executing managing section 115 manages startings of the function program executing section 117, the approval request processing section 119, etc. Concretely, the program executing managing section 115 manages the starting of the function program and its processing passing time, and makes the approval request processing section 119 execute the processing, etc. on the basis of the rule stored in the approval request rule DB 112. The log processing section 116 records the executing log of the function program to the log DB 110, and performs transmission processing of the log to the approval processing terminal 102. The program function executing section 117 sequentially reads the program function stored in the program function DB 111 to the work memory, and executes the program function by the processor 108a. The approval request rule DB changing section 118 updates the approval request rule DB 112. When the approval request rule DB 112 is initialized, the approval request rule DB changing section 118 receives a new password from a user performing the initialization and sets this password to the approval request rule DB 112. It is necessary to input the password in changing the contents at the next time or later. This is because it is necessary to set the approval request rule DB changing section 118 such that no third person can freely change the approval request rule DB 112. The approval request processing section 119 makes the approval request message and performs its transmission processing and the reception processing of an approval result. The authentication processing section 120 performs digital signature processing and signature verification processing with respect to data received from the approval request processing section 119. The time obtaining section 121 obtains the present time. The position obtaining section 130 obtains the locating position of a terminal. For example, the position obtaining section 130 can be constructed by a device receiving the signal of GPS data by a GPS antenna and receiving these data. However, the position obtaining section 130 is not limited to this device if this device has a function able to obtain the position.

The approval processing program 122 executed by the processor 108b of the approval processing terminal 102 functionally has an approval processing rule DB changing section 126, an approval processing section 127, an authentication processing section 120 and an approval log processing section 128. The processor 108b functionally has a time obtaining section 121 in addition to the above functions. The approval processing rule DB changing section 126 updates the approval processing rule DB 123. When the approval processing rule DB 123 is initialized, the approval processing rule DB changing section 126 receives a new password from a user performing the initialization and sets this password to the approval processing rule DB 123. It is necessary to input the password in changing the contents at the next time or later. This is because it is necessary to set the approval processing rule DB changing section 126 such that no third person can freely change the approval processing rule DB 123. The approval processing section 127 receives the approval request message from the approval request terminal 101 and performs the approval processing on the basis of the rule of the approval processing rule DB 123. The authentication processing section 120 performs signature verification processing and digital signature processing with respect to data received from the approval processing section 127. The time obtaining section 121 obtains the present time. The approval log processing section 128 stores the approval request message received from the approval request terminal 101 and the approval result with respect to this message to the approval log DB 125 as a log. Further, the approval log processing section 128 obtains the log of the approval log DB 125 and displays the log to the user through the input/output device 104.

An account settlement program using the UIM (User Identify Module) card, a call function program, an electronic mail program, a browser function program, a game program, etc. are stored in the function program DB 111 of the approval request terminal 101 as various kinds of function programs. The program may be also set to another program if this program is basically a program for realizing various kinds of functions attached to the communication terminal. Further, no quantity of the function program stored in the function program DB 111 is particularly limited except for the memory capacity of this function program DB 111.

The approval request terminal ID 114 and the approval processing terminal ID 124 are set to an electronic mail address, a telephone number, an Internet address, etc. for specifying a communication partner, but are not limited to these addresses, etc. if these IDs are IDs for univocally specifying the terminals, i.e., discriminating information for the communication of the terminals.

As mentioned above, a secret key of the self terminal, a laid-open certificate and the credible route certificate of an authentication station as information for performing the authentication processing in the laid-open key cipher system are stored in the approval request terminal authentication information DB 113 and the approval processing terminal authentication information DB 129. The secret key is used to put a digital signature with respect to data, and is not laid-open to the others. The digital signature is a signature able to certify that it is certainly data from this terminal since the digital signature is data able to be made by only a person having the secret key. The laid-open certificate includes a laid-open key corresponding to the secret key, and is utilized to verify the digital signature of the self terminal by a communication partner. Since the secret key and the laid-open key are different from each other, the laid-open certificate can be freely transmitted. The route certificate is utilized to verify that the laid-open certificate of the communication partner is correct. The approval request terminal authentication information DB 113 and the approval processing terminal authentication information DB 129 are initialized before the approval request terminal 101 and the approval processing terminal 102 are used. Thereafter, the approval request terminal authentication information DB 113 and the approval processing terminal authentication information DB 129 may be updated through the network 103, etc. No information stored in the approval request terminal authentication information DB 113 and the approval processing terminal authentication information DB 129 is limited if this information is information for performing the authentication processing.

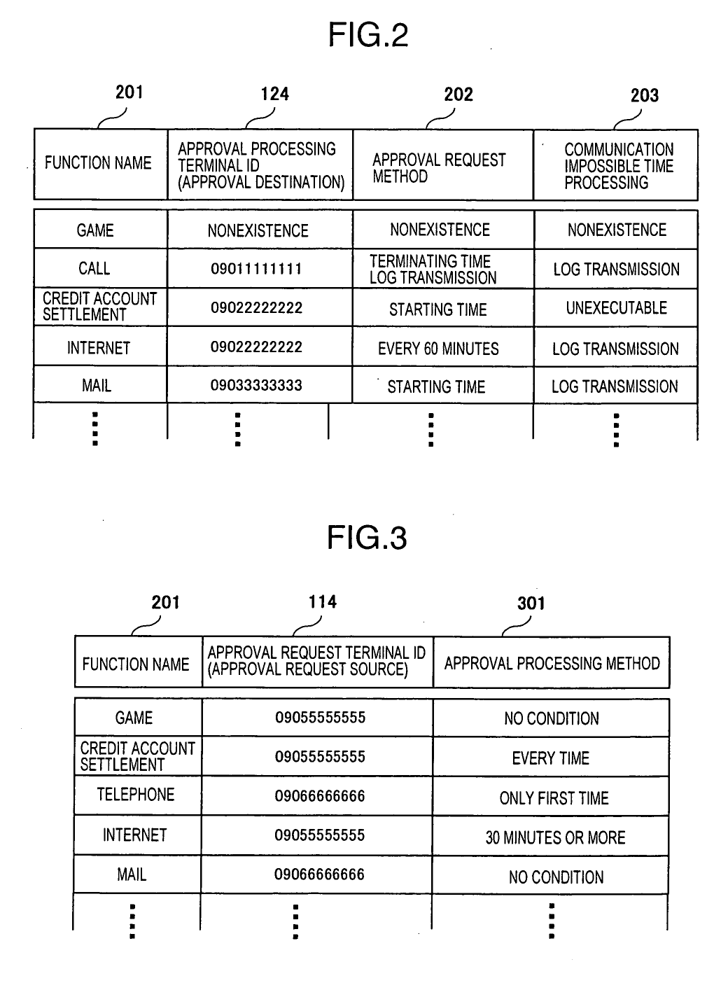

As shown in FIG. 2, an approval processing terminal ID 124, an approval request method 202 and communication impossible time processing 203 every function name 201 are stored in the approval request rule DB 112 of the approval request terminal 101. The function name 201 is the name of a function program. The approval processing terminal ID 124 is the ID of the previous approval processing terminal 102 for transmitting the approval request message with respect to the function program corresponding to the function name 201. The approval request method 202 is a method of the approval request processing when the approval request is required in the execution of the function program corresponding to the function name 201. As this method of the approval request processing, there are “nonexistence” for performing no approval request processing, “starting time” for transmitting the approval request message at the starting time, “every minutes” for transmitting the approval request message every constant time (time is arbitrarily set), and “terminating time log transmission” for transmitting only an execution log at the terminating time. The communication impossible time processing 203 is a processing method executed when no communication for transmitting the approval request can be performed. As this processing method, there are “nonexistence” for requiring no approval, “execution impossibility” for allowing no execution, and “log transmission” for transmitting the log after the processing is terminated. With respect to the function program (game in the example of FIG. 2) which requires no approval and may be set so as to be executable without any condition, these contents are not set to the approval processing terminal ID 124, the approval request method 202 and the communication impossible time processing 203. Before the approval request terminal 101 is used, a user of the approval processing terminal 102, e.g., a parent initializes the approval request rule DB 112 explained above in advance, or a clerk initializes this approval request rule DB 112 in accordance with the request of the parent in a sales shop of the terminals 101, 102. The user (parent) or the clerk of the approval processing terminal 102 inputs the function name 201, the approval processing terminal ID 124, the approval request method 202 and the communication impossible time processing 203 by operating the input/output device 104 with respect to each of the respective function programs stored in the function program DB 111. When the input/output device 104 is operated, the approval request rule DB changing section 118 is operated and stores the input contents to the approval request rule DB 112. With respect to the function name 201, the approval request method 202 and the communication impossible time processing 203, the approval request rule DB changing section 118 displays selecting items in the output device of the input/output device 104. When one of the selecting items is selected, this selected item may be preferably set to the approval request rule DB 112.

As shown in FIG. 3, the approval request terminal ID 114 and an approval processing method 301 every function name 201 are stored in the approval processing rule DB 123 of the approval processing terminal 102. The function name 201 is the name of a program function of the approval request terminal 101. The approval request terminal ID 114 is the ID of the approval request terminal 101. The approval processing method 301 is a method for inquiring of the user of the approval processing terminal 102 about allowance/unallowance of the approval when the approval request message of the program function corresponding to the function name 201 is received from the approval request terminal 101 of the approval request terminal ID 114. As this method, there are concretely “every time” for making an inquiry every reception of the approval request message, “only first time” for making an inquiry with respect to only a first approval request during the execution of the function program, “certain hours or more” for making an inquiry when the utilizing time of the function program is a constant time or more, and “no condition” for requiring no approval. Similar to the above-mentioned initialization of the approval request rule DB 112, before the approval request terminal 101 is utilized, a user of the approval processing terminal 102, e.g., a parent initializes the approval processing rule DB 123 in advance, or a clerk initializes the approval processing rule DB 123 in accordance with the request of the parent in a sales shop of the terminals 101, 102. The user (parent) of the approval processing terminal 102 or the clerk inputs the function name 201, the approval request terminal ID 114 and the approval processing method 301 by operating the input/output device 104 with respect to each of the respective function programs stored in the function program DB 111 of the approval request terminal 101. When the input/output device 104 is operated, the approval processing rule DB changing section 126 is operated and stores the inputted contents to the approval processing rule DB 123. In this case, with respect to the function name 201 and the approval processing method 301, the approval processing rule DB changing section 126 also displays selecting items in the output device of the input/output device 104. When one of the selecting items is selected, this selected item is preferably set to the approval processing rule DB 123.

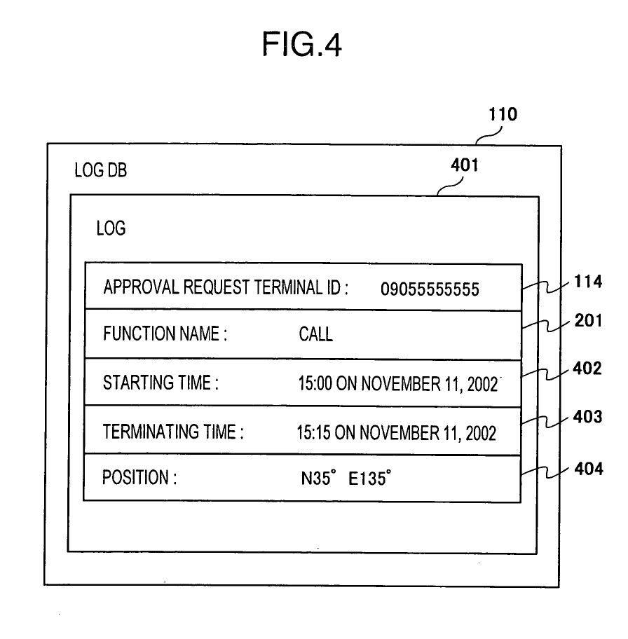

As shown in FIG. 4, the approval request terminal ID 114, the function name 201 of the function program, a starting time 402 as a time of starting of the execution of the function program of this function name, a terminating time 403 as a time of termination of the execution of the function program of the function name, and a place 404 as the place of the approval request terminal 101 at the executing time of the function program of the function name are stored in the log DB 110 of the approval request terminal 101. The log processing section 116 stores the above data in this log DB 110 as a log 401. The log processing section 116 obtains the starting time 402 and the terminating time 403 from the time obtaining section 121, and obtains the place 404 from the position obtaining section 130.

Next, the operations of the approval request terminal 101 and the approval processing terminal 102 will be explained.

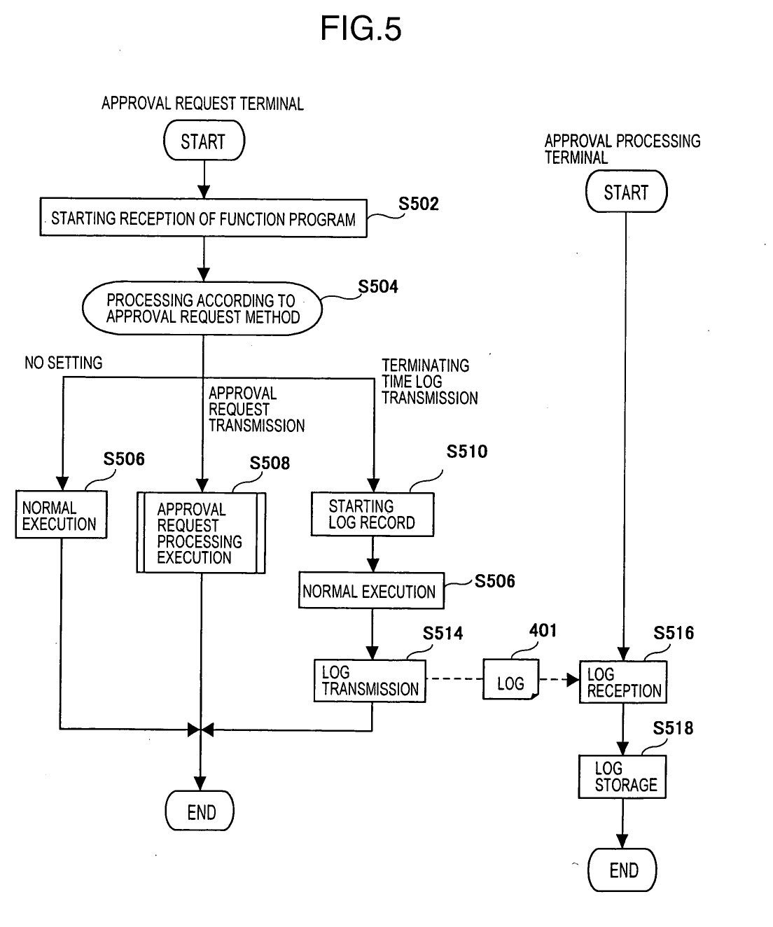

As shown in the flow chart of FIG. 5, when a user of the approval request terminal 101 operates the input/output device 104 and gives commands for starting a predetermined desirable function program (step 502), the program executing managing section 115 starts the approval request processing section 119 and makes this approval request processing section 119 obtain the approval request rule of a pertinent function program from the approval request rule DB 112. The program executing managing section 115 executes processing according to the approval request method 202 of the approval request rule obtained by the approval request processing section 119 (step 504).

When no approval request method 202 of the approval request rule obtained by the approval request processing section 119 is set, the program executing managing section 115 judges that no approval is required in executing this function program, and makes the function program executing section 117 read this function program from the program function DB 111 to the work memory and execute this function program (step 506). When this step 506 is terminated, the processing is terminated.

When the approval request method 202 of the approval request rule obtained by the approval request processing section 119 is “starting time”or “every xx minutes”, i.e., when the transmission of an approval request message is required, approval request processing described later is executed (step 508).

When the approval request method 202 of the approval request rule obtained by the approval request processing section 119 is “terminating time log transmission”, the program executing managing section 115 makes the time obtaining section 121 obtain the starting time 402, and also makes the position obtaining section 130 obtain the position 404 of the approval request terminal 101, and further makes the log processing section 116 store the starting time 402 and the position 404 in the log DB 110 together with the function name 201 (step 510). The program executing managing section 115 so makes the function program executing section 117 execute this function program (step 506). When the execution of this function program is terminated, the program executing managing section 115 makes the time obtaining section 121 obtain the terminating time 403, and makes the log processing section 116 store the terminating time 403 to the log DB 110. Then, the log processing section 116 transmits the log 401 stored in the log DB 110 to the approval processing terminal 102 corresponding to the approval processing terminal ID 124 of the approval request rule obtained in the step 504 through the transmitter-receiver 105 (step 514). When this step 514 is terminated, the approval request terminal 101 terminates the processing.

When the approval processing section 127 of the approval processing terminal 102 receives the log 401 (step 516), the approval log processing section 128 stores this log 401 to the approval log DB 125 (step 518). When this step S518 is terminated, the approval processing terminal 102 terminates the processing.

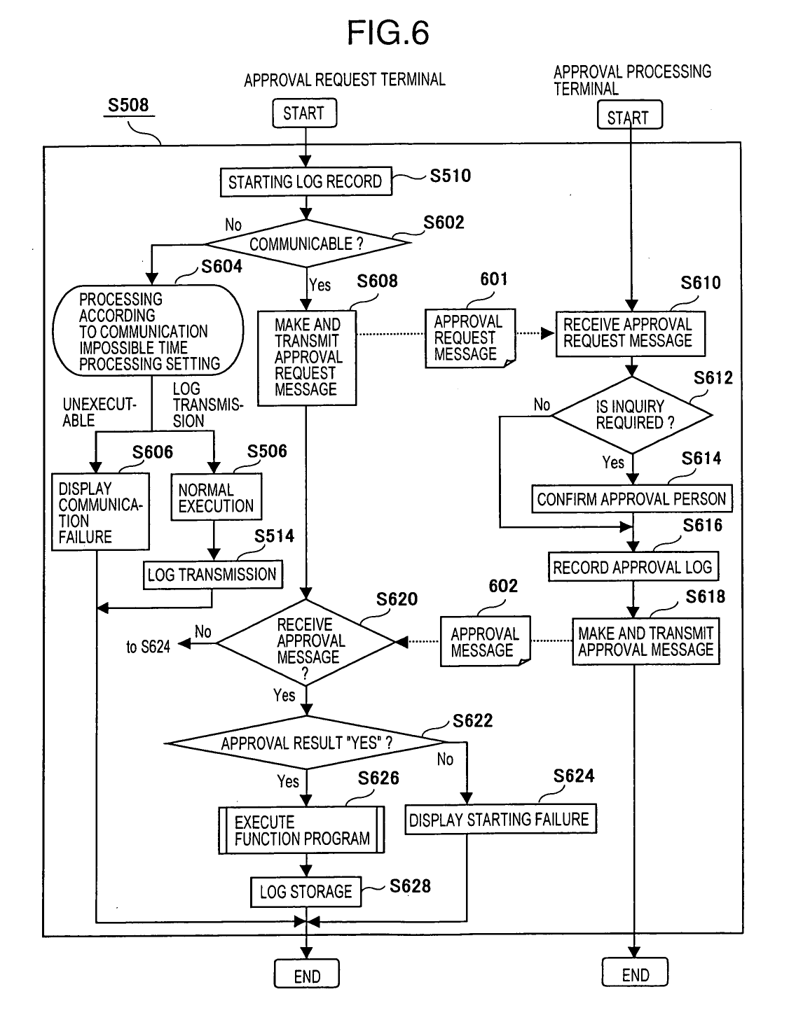

Next, the details of the approval request processing (step 508) executed when the approval request method 202 of the approval request rule obtained by the approval request processing section 119 is the above “starting time” or “every xx minutes”, will be explained in accordance with the flow chart shown in FIG. 6.

First, the program executing managing section 115 makes the time obtaining section 121 obtain the starting time 402, and also makes the position obtaining section 130 obtain the position 404 of the approval request terminal 101, and further makes the log processing section 116 store the starting time 402 and the position 404 to the log DB 110 together with the function name 201 (step 510). Subsequently, the communication situation with the approval processing terminal 102 corresponding to the approval processing terminal ID 124 of the approval request rule obtained in the step 504 is confirmed (step 602). When the communication situation is bad and no approval request message can be transmitted, processing according to the communication impossible time processing 203 of the approval request rule obtained in the step S504 is performed. When “execution impossibility” is set in the communication impossible time processing 203, the program executing managing section 115 makes the input/output device 104 display that the communication is unsuccessful (step 606), and the processing is then terminated. In contrast to this, when “log transmission” is set in the communication impossible time processing 203, the program executing managing section 115 makes the function program executing section 117 execute the function program (step 506).

When the execution of the function program is terminated, the program executing managing section 115 makes the time obtaining section 121 obtain the terminating time 403, and makes the log processing section 116 store the terminating time 403 to the log DB 110. Then, the log processing section 116 transmits the log 401 stored in the log DB 110 to the pertinent approval processing terminal 102 through the transmitter-receiver 105 (step 514). When this step 514 is terminated, the approval request terminal 101 terminates the processing.

When a communicable state is set in the step 602, the program executing managing section 115 makes the approval request processing section 119 make an approval request message 601 and transmit the approval request message to the pertinent approval processing terminal 102 (step 608). At this time, the message maybe ciphered between the approval request terminal 101 and the approval processing terminal 102. In this case, it is necessary to separately arrange a ciphering program of the message in the approval request terminal 101, and separately arrange a deciphering program in the approval processing terminal 102.

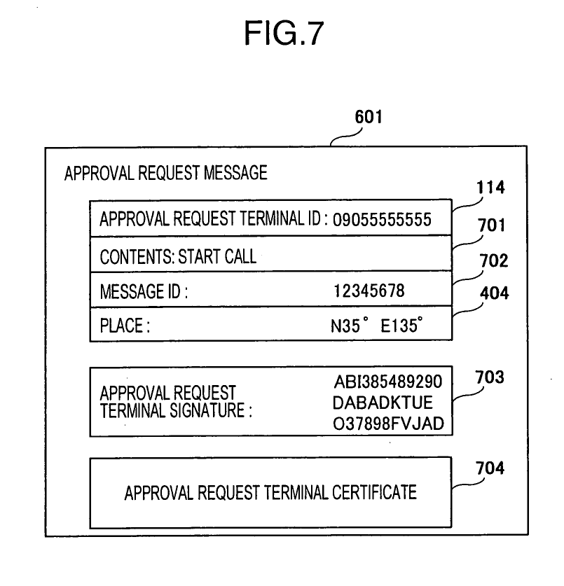

Here, the construction of the approval request message 601 and its making procedure will be explained by using FIG. 7.

First, the approval request processing section 119 generates an effective ID from the starting of a function program executed this time to its termination, and sets this effective ID to a message ID 702. Further, the approval request processing section 119 obtains the approval request terminal ID 114, the function name 201 and the position 404 from the log DB 110, and develops these data onto the work memory as connecting data. The authentication processing section 120 obtains the secret key of a self terminal from the approval request terminal authentication information DB 113, and makes a digital signature calculation with respect to the connecting data connected by the approval request processing section 119, and also generates an approval request terminal signature 703. Then, the approval request processing section 119 makes an approval request message 601 in which the above connecting data, the approval request terminal signature 703 and a laid-open certificate of the self terminal stored in the approval request terminal authentication information DB 113 are connected. The approval request processing section 119 then transmits the approval request message to the pertinent approval processing terminal 102 through the transmitter-receiver 105 as mentioned above (step 608).

The approval processing section 127 of the approval processing terminal 102 receives the approval request message 601 through the transmitter-receiver 105 (step S610) When the approval request message 601 is received, the authentication processing section 120 first verifies whether an approval request terminal certificate 704 of the approval request terminal 101 is right by using the route certificate of an authentication station stored in the approval processing terminal authentication information DB 129. Next, the authentication processing section 120 verifies an approval request terminal signature 703 of the approval request message 601 by using the approval request terminal certificate 704 within the approval request message 601. When the verification is unsuccessful, the processing is interrupted/compulsorily terminated. As a result of the verification, if the signature 703 is correct, it is considered that the message is certainly a message from a partner described in the approval request terminal ID 114 of the approval request message 601 and it proceeds to the processing of a step 612.

The approval processing section 127 obtains the approval request terminal ID 114 of the approval request message 601 and an approval processing rule corresponding to the program function shown by contents 701 from the approval processing rule DB 123, and performs processing according to the approval processing method 301 (step 612).

First, a case requiring display to a user of the approval processing terminal 102 in the processing according to the approval processing method 301 will be explained. When the approval processing method 301 is set to “every time” and “only first time” is set and the approval request message 601 of this program function is first reception (it is judged by a message ID 702 whether this message is the first reception.) and the processing of contents described in the contents 701 shows the passage of time prescribed in the approval processing method 301, the approval processing section 120 makes an approval request message to be displayed in accordance with the approval request message 601, and makes the output device of the input/output device 104 display the request of the approval and makes the user of this approval processing terminal 102 judge and input yes and no of the approval (step 614). The approval processing section 120 sets the input from the user to an approval result, and it proceeds to a step 616.

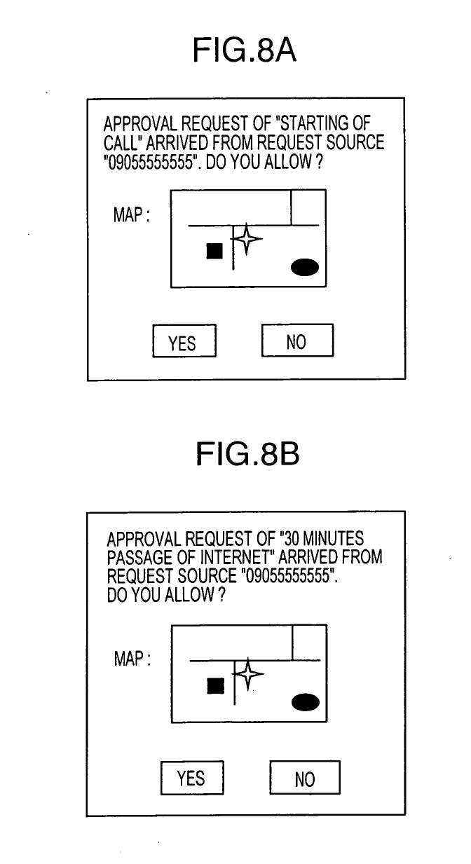

Here, a display example of the approval judgment to the user will be explained by using FIG. 8A and 8B.

For example, when the approval request method 202 is set to “starting time” with respect to a call program, the ID of an approval request source and the message of “An approval request of “starting of call”arrived. Do you allow ?”, and a map showing the present place of the approval request source are displayed as shown in FIG. 8A. Such a limit of the “starting of call” is effective in the case of a far distance call in which this call is made abroad, etc.

Similar to the above case, when the approval request method 202 is set to “starting time” with respect to a credit processing program, for example, “Taro Tokyo (a possessor of the approval request terminal 101) wants to purchase a magazine at “3000” yen in a credit function. Do you allow?” is displayed as a message as shown in FIG. 11.

Further, when the approval request method 202 is set to “every 30 minutes” with respect to an Internet program, the ID of the approval request source and the message of “An approval request of “30 minutes passage of Internet” arrived. Do you allow?”, and a map showing the present place of the approval request source are displayed as shown in FIG. 8B.

When the approval request method 202 is set to “every two hours” with respect to a game program, for example, “An approval request of “two hours passage of game” arrived. Do you allow?” is displayed as a message as shown in FIG. 11. The execution management of this game program is very effective when a child utilizes a game machine with a communication function and a parent wants to manage this game machine. The time limit of the execution of such a function program is also effective in the normal call in addition to the above case.

Next, a case requiring no display to the user of the approval processing terminal 102 in the judgment in the step 612 will be explained. When the approval processing method 301 is “no condition” and no condition is conformed to a condition set to the approval processing method 301, the approval processing section 127 judges that no inquiry of the approval with respect to the user is required, and sets the approval result to “yes” and it proceeds to a step 616.

In the step 616, the approval log processing section 128 stores the received approval request message 601 and the approval result to the approval log DB 125. Then, the approval log processing section 128 makes an approval message and returns the approval message 602 to the approval request terminal 101 corresponding to the approval request terminal ID 124 of the approval request message 601 obtained in the step 610 through the transmitter-receiver 105 (step 618). At this time, the message may be ciphered between the approval request terminal 101 and the approval processing terminal 102. In this case, it is necessary to separately arrange a ciphering program of the message in the approval processing terminal 102, and separately arrange a deciphering program in the approval request terminal 101.

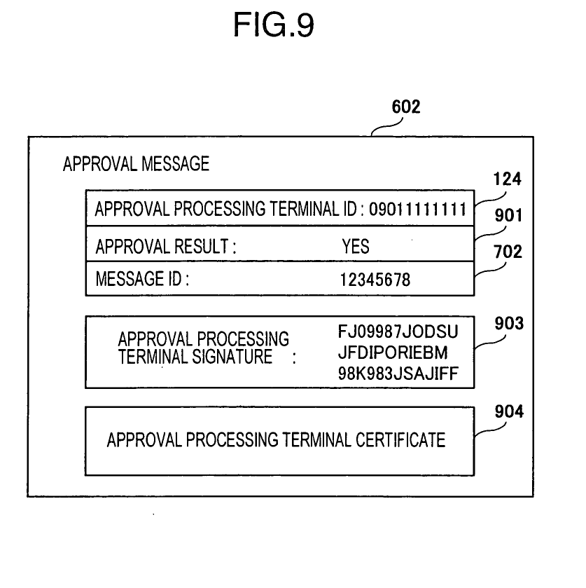

Here, the construction of the approval message 602 and its making procedure will be explained by using FIG. 9.

First, the approval processing section 127 of the approval processing terminal 102 develops the approval processing terminal ID 124, the approval results 901 in steps 612 and 614, and the message ID 702 of the approval request message 601 received in the step 610 onto the work memory as connecting data. The authentication processing section 120 obtains the secret key of the self terminal from the approval processing terminal authentication information DB 129, and the approval processing section 127 makes a digital signature calculation with respect to the connecting data and generates an approval processing terminal signature 903. Then, the approval processing section 127 makes an approval message 602 in which the above connecting data, the approval processing terminal signature 903 and an approval processing terminal certificate 904 of the self terminal stored in the approval processing terminal authentication information DB 129 are connected. The approval processing section 127 then returns the approval message 602 to the pertinent approval request terminal 101 as mentioned above.

The approval request processing section 119 of the approval request terminal 101 receives the approval message 602 through the transmitter-receiver 105, andtransmits this approval message 602 to the authentication processing section 120 (step 620). The authentication processing section 120 verifies the approval processing terminal signature 903 of the approval message 602. The authentication processing section 120 first verifies that the approval processing terminal certificate 904 is right by using the route certificate of an authentication station stored in the approval request terminal authentication information DB 113. Next, the authentication processing section 120 verifies the approval processing terminal signature 903 of the approval message 602 by using the approval processing terminal certificate 904 within the approval message 602. When the verification is unsuccessful or no approval message 602 can be received even when a constant time has passed, it proceeds to a step 624. If the signature 903 is correct as a result of the verification, it is considered that the message is certainly a message from a partner described in the approval processing terminal ID 124 of the approval message 602, and the approval request processing section 119 judges whether the approval result 901 of the approval message 602 is “yes” or “no” (step 622). If the approval result 901 is “no”, the approval request processing section 119 makes the output device of the input/output device 104 display that no approval is performed, and the processing is terminated (step 624). In contrast to this, the approval result 901 is “yes”, the approval request processing section 119 notifies what it is approved to the program executing managing section 115. When the program executing managing section 115 receives this notification, the program executing managing section 115 makes the function program executing section 117 execute the pertinent function program (step 626). When the execution of this function program is terminated, the program executing managing section 115 makes the time obtaining section 121 obtain the terminating time 403 and makes the log processing section 116 store the terminating time 403 to the log DB 110 (step 628).

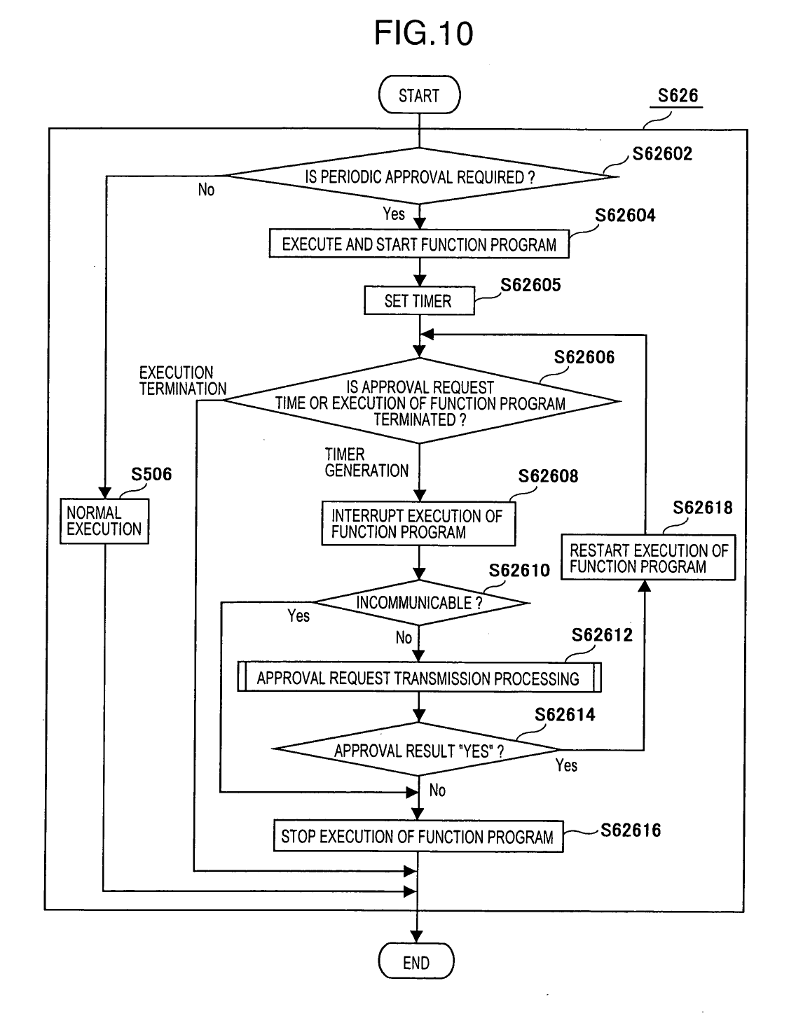

Here, the executing procedure of the function program in the step 626 will be explained in accordance with the flow chart shown in FIG. 10.

First, the program executing managing section 115 of the approval request terminal 101 performs processing according to the approval request method 202 of an approval request rule obtained in the step 504. Namely, the program executing managing section 115 performs processing according to whether the approval request method 202 is “starting time” or “every xx minutes” (step 62602). When the approval request method 202 is set to “starting time”, no approval request is required during the execution. Therefore, the program executing managing section 115 makes the program function executing section 117 execute the function program (step 506). When the execution of the function program is terminated, the processing is terminated.

When the approval request method 202 is set to every constant time, the approval request is periodically transmitted at an assigned time interval. The procedure of the periodic transmission will next be explained. The program executing managing section 115 makes the program function executing section 117 start the execution of the function program (step 62604). Simultaneously, the program executing managing section 115 performs a setting operation so as to generate timer interruption at a time interval assigned in the approval request method 202 (step 62605). The program executing managing section 115 also monitors the timer (monitors an approval request time), and monitors the termination of the execution of the function program (step 62606). When it is judged in the step 62606 that the execution of the function program is terminated, the processing is terminated. When it is judged in the step 62606 that the timer interruption is generated, the program executing managing section 115 makes the function program executing section 117 interrupt the execution of the program function to transmit the approval request (step 62608). Then, the program executing managing section 115 confirms the communication situation with the pertinent approval processing terminal 102 (step 62610). When the communication is impossible in the step 62610, the program executing managing section 115 makes the function program executing section 117 stop the execution of the function program (step 62616), and the processing is terminated. In contrast to this, when the communication is possible in the step 62610, approval request transmission processing is performed similarly to the processing of the above step 608 (step 62612). With respect to this approval request transmission processing, an approval message is transmitted on the approval processing terminal 102 side by the above processings of steps 610 to 618 using FIG. 6, and the approval request processing section 119 of the approval request terminal 101 performs approval message reception processing similarly to the above step 620. Then, it is judged whether the approval result of the approval message is “yes” or “no” (step 62614). If the approval result is “no”, the approval request processing section 119 makes the output device of the input/output device 104 display that no approval is performed, and the execution of the function program is stopped and the processing is terminated (step 62616). In contrast to this, if the approval result is “yes”, the approval request processing section 119 notifies what it is approved to the program executing managing section 115, and makes the function program executing section 117 restart the execution of the function program (step 62618), and it is again returned to the step 62606.

As mentioned above, in this embodiment mode, the user of the approval processing terminal 102 can grip the using situation of the function program of the user of the approval request terminal 101 in real time, and can further set allowance/unallowance of the use of the function program of the approval request terminal 101 and the allowance/unallowance of the use of the function program for a constant time or more. Thus, in this embodiment mode, the approval of the allowance/unallowance of the use of the function program is judged by a person so that a flexible function limit according to situations such as the kind of the function program, position, using time, etc. can be performed.

Further, time and labor of the approval of the user of the approval processing terminal 102 can be reduced by setting the approval processing rule in the approval processing terminal 102. Further, no user of the approval request terminal 101 can freely release the limit of the function program by setting a password to the approval request rule DB 112 and the approval processing rule DB 123 of the approval request terminal 101. Further, a communication partner can be reliably set by mutually authenticating the communication partner between the approval request terminal 101 and the approval processing terminal 102 on the basis of the certification of an authentication station. Further, it is possible to prevent a third person from intercepting a message by ciphering the communication between the approval request terminal 101 and the approval processing terminal 102. Further, the possessor (e.g., a parent) of the communication terminal 102 can grip the utilization situation of the function program in the communication terminal 101 even when only the log of the function program is transmitted from the communication terminal 101 to the communication terminal 102. Thus, the possessor of the communication terminal 102 can direct attention of the possessor (e.g., a child) of the communication terminal 101 to the utilization of the function program.

In the above embodiment mode, the approval request terminal 101 has the approval request function and the approval processing terminal 102 has the approval processing function, but these terminals maybe also set to communication terminals having both the functions. Further, in this embodiment mode, the processing at the communication impossible time is prescribed as the approval request rule. However, the approval request may be temporarily stored at the communication impossible time, and may be also automatically transmitted when the communication is possible. Further, in this embodiment mode, the approval request terminal 101 transmits the approval request in timing for starting the execution of the function program. However, when there is an input of the making request of an approval request message from the user of the approval request terminal 101, the approval request terminal 101 may transmit only the approval request message in advance directly irrespective of the execution of the function program, and may receive an approval allowance message having an effective time limit from the approval processing terminal 102 and may store this approval allowance message. Further, when the approval request terminal 101 receives the execution request of the function program with reference to this approval allowance message, the approval request terminal 101 may execute this function program if it is within the effective time limit.

In accordance with the present invention, when the function program is utilized in a certain communication terminal, or is being utilized, the communication terminal inquires of another communication terminal about the utilization of the function program. Accordingly, the possessor (e.g., a parent and a manager of a company) of another communication terminal can grip the utilization situation of the function program of the possessor (e.g., a child and an employee of the company) of a certain communication terminal, and can set allowance/unallowance of the utilization of the function program, etc. Thus, in the present invention, the approval of the allowance/unallowance of the use of the function program is judged by a person so that a flexible function limit according to situations such as the kind of the function program, position, using time, etc. can be performed.

What is claimed is:

1. A communication terminal comprising a program processor for performing the execution processing of various kinds of programs, and a communicator for performing communication between the communication terminal and the exterior; comprise,
approval request processor for making an approval request message of the execution processing of a predetermined program among said various kinds of programs and transmitting the approval request message to another predetermined communication terminal by said communicator when a predetermined condition is satisfied with respect to the predetermined program; and
a program executing manager for controlling said execution processing using said program processor in accordance with the contents of a reply message to said approval request message when said communicator receives the reply message contents from said another communication terminal.

2. The communication terminal according to claim 1, wherein
said predetermined condition is one of the reception of a starting request of said predetermined program, the passage of a predetermined executing time interval with respect to the predetermined program, and the reception of a making request of said approval request message from a user with respect to the predetermined program.

3. The communication terminal according to claim 1, wherein
said program executing manager makes said program processor perform the execution processing of the predetermined program if said reply message shows contents recognizing the execution of the predetermined program with respect to the execution processing of said predetermined program requesting the approval in said approval request message, and also makes said program processor perform no execution processing of the predetermined program if the reply message shows contents recognizing no execution of the predetermined program.

4. The communication terminal according to claim 1, further comprises,
position information obtaining means which obtains information of the present place of the self communication terminal, wherein,
said approval request processor includes the position information obtained by said position information obtaining means in said approval request message.

5. The communication terminal according to claim 1, further comprises,
an approval request rule memory for storing a rule with respect to the approval request every each of said various kinds of programs, wherein,
said approval request processor performs processing in accordance with said rule stored in said approval request rule memory.

6. The communication terminal according to claim 5, wherein
said rule includes information of communication impossible time processing for determining what processing is performed with respect to said predetermined program at the communication impossible time with said another predetermined communication terminal.

7. The communication terminal according to claim 5, wherein
with respect to one of programs except for said predetermined program among said various kinds of programs, said rule includes the transmission of an execution log of this program instead of the transmission of said approval request message.

8. The communication terminal according to claim 1, wherein
said predetermined program is a game program and
the communication terminal is a game machine.

9. A communication terminal comprising input means which receives an input from a user, output means which outputs information, and communicator for performing communication between the communicator and the exterior, comprises,
an approval processor which makes said output means output contents based on an approval request message showing the desire of approval with respect to the execution of a predetermined program when said communicator receives the approval request message from another communication terminal, and
makes a reply message based on a reply to the approval request message when said input means receives the input of the reply, and transmits the reply message to the another communication terminal by the communicator.

10. The communication terminal according to claim 9, further comprises:
log memory for storing a log of the program executed by said another communication terminal, and
log processor for storing the log in said log memory when said communicator receives said log from said another communication terminal, and calling the log out of the log memory and outputting the log to said output means when a perusing request of the log is received by said input means.

11. A communication system comprises:
the communication terminal according to claim 1; and
the communication terminal according to claim 9 which receives said approval request message from said communication terminal and returns said reply message to the approval request message.

12. A portable telephone set comprising program processor for performing the execution processing of various kinds of programs, and communicator for performing communication between the communicator and the exterior, comprises,
with respect to a predetermined program among said various kinds of programs, log processor for transmitting a log of the predetermined program to another predetermined communication terminal by said communicator when the predetermined program is executed and processed by said program processor.

13. A portable telephone set comprising input means which receives an input from a user, output means which outputs information, and communicator for performing communication between the communicator and the exterior;
the portable telephone set further comprising:
log memory for storing the log of a program executed by another communication terminal; and
log processor for storing the log in said log memory when said communicator receives said log from said another communication terminal, and calling the log out of the log memory and outputting the log to said output means when a perusing request of the log is received by said input means.

14. An operation program of a communication terminal comprising program processor for performing the execution processing of various kinds of function programs, and communicator for performing communication between the communicator and the exterior, executes:
an approval request processing step which makes an approval request message of the execution processing of a predetermined function program among said various kinds of programs when a predetermined condition is satisfied with respect to the predetermined function program, and transmits the approval request message to another predetermined communication terminal by said communicator; and
a program executing managing step which controls said execution processing using said program processor in accordance with the contents of a reply message to said approval request message when said communicator receives the reply message from said another communication terminal.

15. An operation program of a communication terminal comprising input means which receives an input from a user, output means which outputs information, and communicator for performing communication between the communicator and the exterior, executes:
an approval processing step in which said output means outputs contents based on an approval request message showing the desire of approval with respect to the execution of a predetermined program when said communicator receives the approval request message from another communication terminal; a reply message based on a reply to the approval request message is made when said input means receives the input of the reply; and the reply message is transmitted to the another communication terminal by the communicator.

16. An operation program of the communication terminal comprises:
the operation program of the communication terminal for the approval request according to claim 14, and
the operation program of the communication terminal for the approval processing according to claim 15.

17. A managing method of the program execution of a communication terminal having program processor for performing the execution processing of various kinds of programs, wherein,
said communication terminal makes an approval request message of the execution processing of a predetermined program among said various kinds of programs and transmits the approval request message to another predetermined communication terminal when a predetermined condition is satisfied with respect to the predetermined program;
said another communication terminal outputs contents based on the approval request message with respect to said predetermined program when said approval request message is received from said communication terminal, and makes a reply message based on a reply to the approval request message when the input of the reply is received, and transmits the reply message to the communication terminal; and
said communication terminal controls the execution processing of said predetermined program using said program processor in accordance with the contents of the reply message to said approval request message when the reply message is received from said another communication terminal.
